(19) United States
(12) Patent Application Publication
(10) Pub. No.: US 2026/0306972 A1
(43) Pub. Date: Oct. 8, 2026

(54) FILTERING DEVICE AND REACTION VESSEL AND METHOD FOR MANUFACTURING AQUEOUS SLURRY USING THE SAME

(71) Applicant: UMICORE BATTERY MATERIALS FINLAND OY, Kokkola (FI)

(72) Inventors: Ville HASSINEN, Kokkola (FI); Arto FRÄNTI, Kokkola (FI); Pekka MAASALO, Kokkola (FI); Janne MARJELUND, Kokkola (FI); Janne NIITTYKOSKI, Kokkola (FI); Sofia PELTOSAARI, Kokkola (FI)

(21) Appl. No.: 19/480,549

(22) PCT Filed: May 3, 2024
(86) PCT No.: PCT/EP2024/062186

§ 371 Date: Oct. 31, 2025

(30) Foreign Application Priority Data
May 5, 2023 (EP) 23171870.1

(51) Int. Cl. B01D 29/11; B01D 29/92; B01D 39/16; B01D 39/20

(52) U.S. Cl. CPC B01D 29/11; B01D 29/92; B01D 39/1692; B01D 39/2068

(57) ABSTRACT

It is disclosed a filtering device (100, 200, 300) that comprises a conduit (10) comprising an inlet (30) and an outlet (20). The filtering device also comprises a filter module (90) comprising a tubular filter (40) having a first end (40a) and a second end (40b), the first end (40a) being open, and the second end (40b) being sealed. The filter module (90) comprises a suction tube (60) arranged to extend inside of the tubular filter (40) between the first end (40a) and the second end (40b). The extending of the suction tube (60) inside of the tubular filter (40) being such that there is an intermediate space (80) between the tubular filter (40) and the suction tube (60) that is fluidly connected to the inlet (30) of the conduit (10) via the suction tube (60). A reaction vessel and a method for manufacturing an aqueous slurry are also disclosed.

### CROSS-REFERENCE TO RELATED APPLICATIONS

This application is a U.S. National Stage Application of International Patent Application No. PCT/EP2024/062186, filed on May 3, 2024, which claims priority to European Patent Application No. 23171870.1, filed on May 5, 2023.

### TECHNICAL FIELD

Generally, the present invention relates to a filtering device and a reaction vessel and a method for manufacturing an aqueous slurry using the same. Particularly, however not exclusively, the present invention relates to a filtering device for a reaction vessel suitable for solid-liquid separation.

### BACKGROUND

In lithium-ion secondary batteries the lithium-transition metal oxides of a cathode-active material are generally manufactured from the precursor material of transition-metal hydroxides or its oxidized forms or transition-metal carbonates manufactured in turn in co-precipitation processes. Such precipitation processes comprise commonly admixing of liquid reactants of a metal salt solution and an aqueous solution of a precipitant with the existence of a potential complexing agent.

These precursor synthesis reactions are maintained from several hours to tens of hours depending on the size and growth rate of the precipitated particles obtained during the process. Therefore, in the case of batch precipitation processes when the volume of the raw materials, i.e. reactants, fed into the reactor exceeds the limit of the reactor, a partial liquid portion removal, i.e. a partial mother liquid removal, by a solid-liquid separating, i.e. filtering, may be performed to continue the precipitation.

Commonly used mother liquid removal methods include external concentrators where the solid-liquid separating is performed outside of the reactor and the separated solids are then circulated back to the reactor. This causes a problem of varying the quality such as in the particle size between the synthesized precursors since the particles which are involved in the solid-liquid separating outside the reactor are not participating in the precipitation synthesis inside the reactor. In addition, the external concentrators also do not allow synthesizing either a gradient-like metal content or a core-shell structure for the precursor particles, for instance.

In view of above, there is a need for further improvements in the solid-liquid separating devices and methods to improve the physical quality and other properties of the precursor materials.

### SUMMARY OF THE INVENTION

It is therefore an object of the present invention to provide a filtering device for a reaction vessel, i.e. a reaction container, that is suitable for a solid-liquid separation without removing the solid fraction from the reaction vessel during the manufacturing of the aqueous slurry. It is a further object of the present invention to provide a reaction vessel that comprises the filtering device.

It is still a further object of the present invention to provide a method for manufacturing an aqueous slurry where the solid-liquid separation is performed by using the filtering device.

In a first aspect an object of the invention is solved by providing a filtering device according to claim 1. The filtering device comprises a conduit comprising an inlet and an outlet and is for conducting a filtrate, i.e. the liquid to be filtered, to outside of the reaction vessel. In other words, the conduit is arranged to direct/pass a filtrate from its inlet to its outlet. The filtering device also comprises a filter module comprising a tubular filter having a first end and a second end. The first end of the tubular filter is open, and a second end of the tubular filter being sealed, i.e. closed. The filter module comprises a suction tube arranged to extend inside of the tubular filter between the first end and the second end of the tubular filter. The suction tube is arranged to extend inside of the tubular filter such that there is an intermediate space between the tubular filter and the suction tube. Further, the suction tube is arranged to be connected to the inlet of the conduit such that the intermediate space is fluidly connected to the inlet of the conduit via the suction tube.

The intermediate space is understood as an inside space of the filter module being formed between an interior wall of the tubular filter and an exterior wall of the suction tube. Advantageously the intermediate space is an inside space that is otherwise closed, i.e. sealed, but includes an opening at the side of the second end of the tubular filter. Said opening is arranged to provide a fluid connection to inside of the suction tube. In other words, the suction tube is arranged to provide an isolated fluid connection between the intermediate space and the inlet of the conduit, such that once the liquid/solution is filtered through the tubular filter, the filtered liquid/solution, i.e. filtrate, passes into the suction tube and subsequently to inside of the conduit. Advantageously, said opening is disposed in proximity to the second end of the tubular filter.

One of the advantages achievable with the suction tube is that when the filtering device is in use there is not a liquid pillar inside the intermediate space and all the filtrate therefrom is arranged to pass the end, i.e. head, of the suction tube toward the second end of the tubular filtered, maximizing thereby the effective filter area of the tubular filter.

When the filtering device is in use for solid-liquid separating, the tubular filter of the filter module is destined to locate at least partially inside the reaction vessel, and the outlet of the conduit is connected to a suction pump, such as a gas suction pump (e.g. a liquid ring vacuum pump, a roots pump etc.), destined to create a vacuum inside the filtering device. Thus, when the filtering device is in use for solid-liquid separating there is a vacuum inside the conduit and the filter module connected thereto via a connection between the inlet of the conduit and the suction tube. When the filter module is at least partially below the liquid level inside the reactor a liquid inside the reactor can pass through the tubular filter inside the intermediate space of the filter module due to the vacuum. Thereby inside the intermediate space the filtrate passes to the suction tube via its end that is towards the second end of the tubular filter. The filtrate inside the suction tube is then directed to the inlet of the conduit and further outside of the filtering device via the outlet of the conduit.

Thus, the filtering device according to the invention provides several advantages compared to the existing external concentrators when it is used in solid-liquid separating in a precipitation process. For instance, it allows to narrow the size distribution of the precipitated particles. Further, it allows to synthesize a gradient-like metal content and a core-shell structure for the precursor particles. Thus, the physical quality and other properties of the precursor materials can be better improved and/or controlled.

Advantageously, the filter module is designed such that the suction tube extends proximity to the second end of the tubular filter. This allows to maximize the effective filter area, i.e. the area actually available for particulate filtration, of the tubular filter.

One of the advantages of the filtering device is that it is possible to install/mount onto the top part of the reaction vessel, such as onto a lid of the vessel. Advantageously, this mounting, i.e. the joint of the filtering device and the reaction vessel, is done such that it is airtight. When the filtering device is mounted onto the top part of the reaction vessel it is destined that the filter module is at least partially inside the reaction vessel. Advantageously, the tubular filter is inserted such that all its effective filter area is destined to be below the desired liquid level.

In some embodiments the tubular filter includes a flat sheet membrane filter such as a fabric, which is arranged into a tubular form, for example by sewing, gluing, or welding. The flat sheet membrane filter is advantageously a multifilament fabric made of polymeric material such as polyester and/or polypropylene etc. If the tubular filter comprises a fabric as a filter media, the tubular filter may further comprise a supporting frame whereto the fabric is supported, to ensure maintaining the tubular form.

In some embodiments the tubular filter is, at least partially, disposed in-line with a part of the suction tube being extended between the first end and the second end of the tubular filter.

Advantageously, the joint between the conduit and the filter module is airtight. In some embodiments an end, i.e. head, of the inlet of the conduit and the end of the suction tube that is destined to be joined with the inlet are both threaded arranged to fit together. When said threads are threaded together a sealed connection between the suction tube and the conduit can be provided, for instance. So configured, a filtrate inside of the suction tube can enter the inlet of the conduit and sequentially pass through the conduit and exit the conduit from the outlet of the conduit. Additionally or alternatively, the head of the inlet of the conduit may comprise a female fitting that sealing engages a Luer fitting or the like with the filter module to provide said sealed connection. The advantage that the joint between the conduit and the filter module is airtight is that the vacuum inside the intermediate space is maximized and hence the filtering performance of the filtering device.

According to an embodiment an end of the intermediate space toward the conduit is sealed. For instance, said end may be sealed by a hollow cap arranged to fit the exteriors of the inlet of the conduit and the tubular filter. Additionally or alternatively, the filter module may comprise a sealing member arranged to extend inside the intermediate space to seal it from the side of the first end of the tubular filter and to join to a part of the exterior of the suction tube and/or the inlet of the conduit that is outside from the tubular filter.

The tubular filter comprises a plurality of pores in its filter media, i.e. filter medium, filtration medium etc., preferably sub-micrometer-sized and/or micrometer-sized pores, adapted for solid-liquid filtration through the tubular filter. Advantageously, in some embodiments, the filter media of the tubular filter is adapted for solid-liquid filtration, allowing to pass through the filter media only particles having the size of 0.5 μm or less, preferably 0.3 μm or less. In other words, the tubular filter has a porosity character that can be designed according to what sized solids it is intended to avoid from passing through it during the liquid-solid filtration.

In characterizing the porosity of filter membranes or filter media, in terms of e.g. total porosity %, total pore area and median pore diameter, Hg porosity measurement method(s) can be used.

The tubular filter may comprise a porous membrane. Additionally or alternatively, the tubular filter may be a tubular filter membrane.

According to an embodiment the tubular filter comprises a membrane being made of a polymeric material, preferably thermoplastic polymer, preferably wherein the polymeric material comprises polyamide, polyethylene, and polytetrafluoroethylene or any combinations thereof.

In some embodiments the filter media is made of high-density polyethylene (HDPE).

According to an embodiment the tubular filter comprises a membrane being made of a ceramic, preferably wherein the ceramic is made from inorganic material comprising alumina, titania, zirconia oxide, and silicon carbide or any mixture thereof.

The porosity of the tubular filter, such as a porosity of the membrane of the tubular filter, may be fabricated by thermal sintering of particles of the filter media or membrane, for instance. Since the tubular filters and particularly tubular filter membranes are known per se, the skilled reader can provide the tubular filters suitable for an application where the present filtering device is applied. Alternatively, the filter media may consist of a flat sheet membrane filter, as described hereinabove.

According to an embodiment the tubular filter has a nominal pore size in a range of approximately 0.1 μm to approximately 20.0 μm, preferably in a range of approximately 0.2 μm to approximately 20.0 μm, more preferably in a range of approximately 0.3 μm to approximately 15.0 μm. As appreciated by the skilled person, the nominal pore size depends on the application of the filtering device. For instance, determining what kind of porosity characteristics, such as the pore sizes, for the filter media to be used, depends on the particle size of the solids that is designed to be filtered.

In characterizing the porosity of filter membranes, in this disclosure, a term of “nominal pore size” refers to the diameter of the smallest particle that cannot pass through the membrane. Porosimetry is commonly used to determine the nominal pore size. The First Bubble Point (FBP) as defined by ASTM F-316-03 (2011) “Standard Test Methods for Pore Size Characteristics of Membrane Filters by Bubble Point and Mean Flow Pore Test” is commonly used for characterizing nominal pore sizes of filter membranes.

According to an embodiment the suction tube comprises a tubular wall that is impermeable to the filtrate, i.e. the liquid to be filtered. This has the advantage that there is not a liquid pillar inside the intermediate space and all the filtrate therefrom is arranged to pass the end, i.e. head, of the suction tube toward the second end of the tubular filtered, i.e. the effective filter area may be maximized. The suction tube may be made of stainless steel, for instance.

According to an embodiment the filtering device comprises a plurality of filter modules installed apart from each other, wherein each intermediate space of the plurality of the filter modules being fluidly connected to the inlet of the conduit.

The plurality of filter modules may be arranged either side-by-side or in a circular pattern or both to form a bundled configuration that allows increasing total effective filter area and hence the performance of the filtering device.

The plurality of filter modules can be configured in such a way that a single inlet of the conduit can be used to receive the filtrate of multiple filter modules. For instance, multiple tubular filters may be arranged in a connected belt-like configuration connected to a single suction tube branching to these multiple tubular filters. Alternatively, multiple tubular filters may each have a separate suction tube connected to a separate inlet of the conduit.

According to an embodiment the filtering device comprises a plurality of filter modules and the conduit comprises a plurality of inlets, wherein each intermediate space of the plurality of the filter modules being fluidly connected to one inlet.

According to an embodiment the filtering device comprises a stem disposed such that a proximal end of the stem being secured to the conduit and a distal end of the stem being secured to a support member. The stem is arranged to support a plurality of the filter modules to the conduit of the device. In this embodiment the second ends the tubular filters of the plurality of filter modules are supported by the support member from a side of the support member facing towards the conduit. Preferably, the stem being disposed, at least partially, in line with the plurality of filter modules.

According to an embodiment the second end of tubular filter of each filter module is installed in a respective support element of the support member. Preferably, an elastic element, such as a spring or the like, is disposed between the second end of the tubular filter and the support member. The elastic member is destined to adapt possible length variations of the filter modules supported to the same support member.

According to an embodiment the plurality of filter modules is arranged in a circular pattern. Preferably, the stem is positioned inside the circular pattern. The effect of said circular pattern is that the effective filter area and the space required in a lateral direction, when the tubular/longitudinal direction of the filter module is in vertical direction, can be optimized. In other words, the filter modules are then positioned in such a way that they are rinsed effectively inside the reactor during the precipitation process. Such a pattern of filter modules also advantageously forms a baffle inside the reactor when mounted therein in addition or instead of the original baffle(s) of the reactor.

When the filtering device is used and there is difficulty to maintain the filter performance uniform due to contamination and/or partial clogging of the tubular filter, it is preferable to restore/control the performance by executing a purging step by back pulsing or back blowing to the filter module, i.e. by creating a positive, pulse-type pressure inside the filter module.

According to an embodiment the conduit comprises a gas inlet which is arranged to allow said purging step.

According to an embodiment the conduit comprises an inside space, wherein the inlet of the conduit and the outlet of the conduit are fluidically connected via the inside space of the conduit, and wherein the inlet of the conduit extends higher to inside space compared to the outlet of the conduit when viewed from side in a way that the second end of at least one tubular filter points downward. The advantage of that is that the backflow of the filtrate to the tubular filter is avoided.

In a second aspect an object of the invention is solved by providing a reaction vessel suitable for precipitating hydroxide or oxyhydroxide of one or more metal elements which reaction vessel comprising a filtering device according to the first aspect of the invention.

According to an embodiment the reaction vessel comprises an external filtrate storage tank fluidly connected to the outlet of the filtering device for storing the filtrate separated through the filtering device.

In a third aspect an object of the invention is solved by providing a method for manufacturing an aqueous slurry. The method comprises supplying and mixing a first aqueous solution comprising a metal salt of one or more elements, preferably the one or more elements include at least one of Ni, Co and Mn, and a second aqueous solution comprising a precipitant in a reaction vessel, thereby forming an aqueous slurry comprising a liquid fraction, i.e. a mother liquid, and a solid faction, i.e. a precipitate. When a predetermined liquid level inside the reaction vessel is reached the method further comprises increasing the solid fraction of the aqueous slurry by vacuum filtrating the aqueous slurry inside the reaction vessel through a filtering device according to the first aspect.

According to an embodiment the precipitant comprises a hydroxide or at least one selected from a carbonate and a bicarbonate. The hydroxide can be an alkali metal hydroxide, such as NaOH. The carbonate can be ammonium carbonate or potassium hydrogen carbonate, for instance and the bicarbonate can be sodium bicarbonate, for instance.

According to an embodiment the method further comprising supplying and mixing a third aqueous solution comprising a complexing agent in the reaction vessel. Preferably the complexing agent is selected from ammonia, glycine, tartrate, citrate, and oxalate. Preferably the complexing agent is ammonia.

Various embodiments according to the present invention are disclosed in the claims as well as in the description. The embodiments and examples recited in the claims and in the description are mutually freely combinable unless otherwise explicitly stated. Throughout the entire disclosure, if any numerical ranges are provided, the ranges also include the endpoint values unless otherwise explicitly stated.

In the following, embodiments of the invention are explained in more detail based on the figures. Identical reference signs thereby refer to identical or corresponding elements and their unnecessary redescription has been avoided.

### BRIEF DESCRIPTION OF THE FIGURES

FIGS. 1A and 1B show a first advantageous design 100 of the filtering device.

FIGS. 2A and 2B show a second advantageous design 200 of the filtering device.

FIGS. 3A and 3B show a third advantageous design 300 of the filtering device.

FIG. 4 shows an advantageous design 400 of the pattern of the filter modules.

FIG. 5 shows an advantageous design 500 of the filter module.

FIG. 6 shows another advantageous design 600 of the filter module.

FIG. 7 shows SEM images of two examples 701 and 702 of the filter media.

FIG. 8 shows an advantageous design 800 of the reaction vessel.

### DETAILED DESCRIPTION OF THE INVENTION

In the following detailed description, preferred embodiments are described in detail to enable the practice of the invention. Although the invention is described with reference to these specific preferred embodiments, it will be understood that the invention is not limited to these preferred embodiments. To the contrary, the invention includes numerous alternatives, modifications and equivalents as will become apparent from the consideration of following detailed description and accompanying drawings.

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

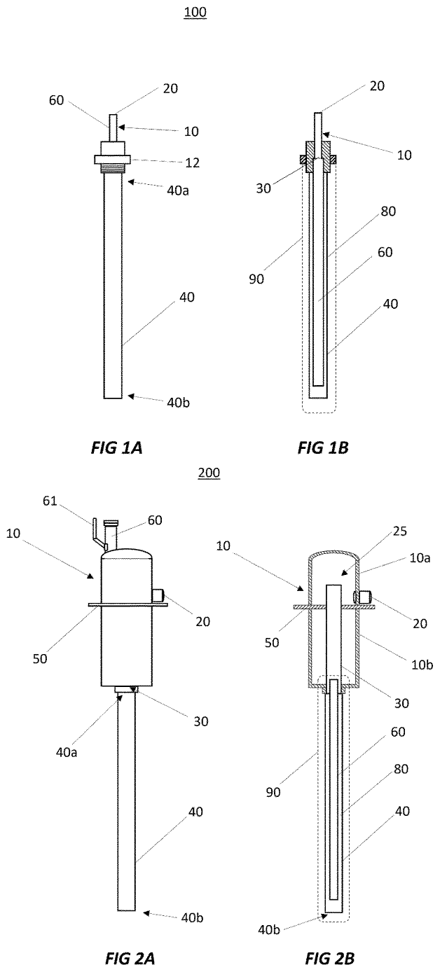

Referring to the figures in detail, FIGS. 1A and 1B show a first advantageous design 100 of the filtering device. FIG. 1A is a side view and FIG. 1B is a side cross-sectional view of it 100, respectively. The filtering device has a conduit 10, a filter module 90 and a hollow connector 12. In this example the conduit 10 is a hollow tube whose one end is an inlet 30 and another end is an outlet 20. The conduit 10, pointing vertically in the figures, is adapted to a filter module 90 and a hollow connector 12. The inlet 30 forms a connection with an end of a suction tube 60 of the filter module 90, i.e. the inlet is adapted to receive a filtrate from the suction tube 60. The filter module 90 also includes a tubular filter 40 having a filter media. The tubular filter 40 surrounds the suction tube 60 such that there is an intermediate space 80 between an interior wall of the tubular filter 40 and an exterior wall of the suction tube 60. The suction tube 60 extends inside of the tubular filter 40 between a first end 40a and a second end 40b of the tubular filter 40. The intermediate space 80 continues at the side of the second end 40b of the tubular filter 40 such that a filtrate inside the intermediate space 80 is allowed to pass an open end of the suction tube 60 pointing towards the second end 40b, i.e. the end of the suction tube 60 that points downward in the figure. In other words, the intermediate space 80 is fluidly connected to the inlet 30 via the suction tube 60. In this example the hollow connector 12 seals the end of the intermediate space 80 at the first side 40a of the tubular filter 40.

The hollow connector 12 is not essential for the invention. With or without a hollow connector 12, is depending on the materials used. For example, the tubular filter can be designed to be welded, glued etc. against to the suction tube at the first end 40a of the tubular filter such that the intermediate space 80 is sealed at that end.

The hollow connector 12 may comprise threading or a collar or both in its exterior adapted to provide mounting means of the filtering device to a reaction vessel, as shown for the design 100 in the figures.

When the filtering device is in use for solid-liquid separating the tubular filter 40 of the filter module 90 is destined to locate at least partially inside the reaction vessel, which is shown in FIG. 7 for the design described hereinbelow, and the outlet 20 of the conduit 10 is connected to a suction pump or the like destined to create a vacuum inside the filtering device.

The filtering device is advantageously mounted on top of a reaction vessel such that at least a part of the filter media of the tubular filter 40 is to be located below a determined/desired liquid level inside of the reaction vessel. To obtain a good filtering performance for the filtering device when it is in use the filter media of the tubular filter is disposed completely below the liquid level. This results in suctioning liquid/solution through the tubular filter 40 but not suctioning gas from a possible gas/atmosphere space, i.e. a space between a reaction vessel lid and a liquid surface inside the reaction vessel, to the intermediate space 80.

FIGS. 2A and 2B show a second advantageous design 200 of the filtering device. It 200 differs from the design 100 in that that the conduit 10 comprises a vessel having an inside space 25. This inside space 25 is formed by an exterior wall 10a and a flange 50 of the conduit. When the design 200 is viewed from side as in the figures the inlet 30 of the conduit 10 extends higher to the inside space 25 compared to the outlet 20 of the conduit 10. This results in avoiding the backflow of the filtrate to the tubular filter.

The inlet 30 and the outlet 20 are fluidically connected via the inside space 25 of the conduit 10. When the filtering device is in use and the outlet 20 is connected to a vacuum pump a filtrate thereby enters into the inside space 25 via the inlet 30 and exits from the outlet 20.

In the design 200 the flange 50 has both external and internal parts. The internal part of the flange closes the inside space 25 together the exterior wall 10a. In some embodiments the flange 50 may comprise either an external part or internal part or both.

The design 200 of the filtering device further comprises a frame 10b below the inside space 25 formed by an exterior wall 10b and the flange 50. Advantageously this frame 10b is adapted to the end of the inlet 30 joined together with the suction tube 60.

The external part of the flange 50 can be used as mounting means to mount the filtering device 200 to a reaction vessel. In this case it is destined that below, as shown in the figures, the flange 50 the filtering device is to be located inside the reaction vessel. Advantageously the frame may be dimensioned in such a way that the end of the frame 10b towards the second end of the tubular filter 40 is in a region of the predetermined liquid level of the reaction vessel when the filtering device is in use.

Advantageously, the inside space 25 is a pressure vessel. The design 200 comprises a gas inlet 60 which is arranged to allow back blowing e.g. N2 gas inside the filtering device for removing contamination from the tubular filter.

The gas inlet 60 comprises a valve 61 for allowing said back blowing. During said back blowing, advantageously, a filtrate discharge line, which is connected to the outlet among the vacuum pump or the like, is closed to direct the blown gas completely to the filter module 90.

FIGS. 3A and 3B show a third advantageous design 300 of the filtering device. It 300 differs from the design 200 in that it comprises a plurality of filter modules 90.

In the design 300 the filter modules 90 are installed apart from each other. Each intermediate space 80 of the plurality of the filter modules 90 is fluidly connected to one inlet 30.

In some embodiments the plurality of filter modules 90 are connected to the same inlet 30, not shown in the figures.

The plurality of filter modules may be arranged either side-by-side or in a circular pattern or both to form a bundled configuration that allows to increase total effective filter area and hence the performance of the filtering device.

In the design of 300 the filtering device further comprises a stem 95 fixed between the conduit 10 and a support member 85 for supporting the filter modules 90. A proximal end 95a of the stem 95 is secured to the bottom of the conduit 10 facing towards the second end 40b of the tubular filters 40. A distal end 95b of the stem 95 is secured to the support member 85 on a side of it 85 facing toward the conduit. In this design 300 the second ends 40b the tubular filters 40 are thereby supported by the support member 85 from a side of the support member 85 facing towards the conduit 10. The stem 95 is in line with the filter modules.

In the design of 300 the filtering device the second end 40b of the tubular filter 40 of each filter modules 90 is installed in a respective support element 86 of the support member 85. In some embodiments the support member 85 comprises an elastic element disposed between the second end 40b of the tubular filter and the support member 85. The elastic element is not shown in the figures. The elastic member is destined to adapt possible length variations of the filter modules supported to the same support member.

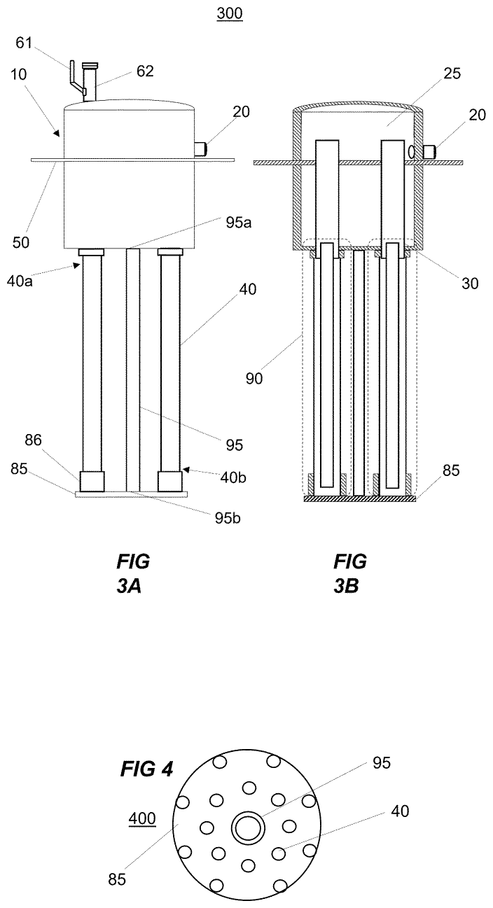

In some embodiments the plurality of filter modules is arranged in a circular pattern. Preferably, the stem is positioned inside the circular pattern. Such an advantageous design 400 of the filter modules is shown in FIG. 4. The figure shows a bottom view of 16 tubular filters of the filter modules.

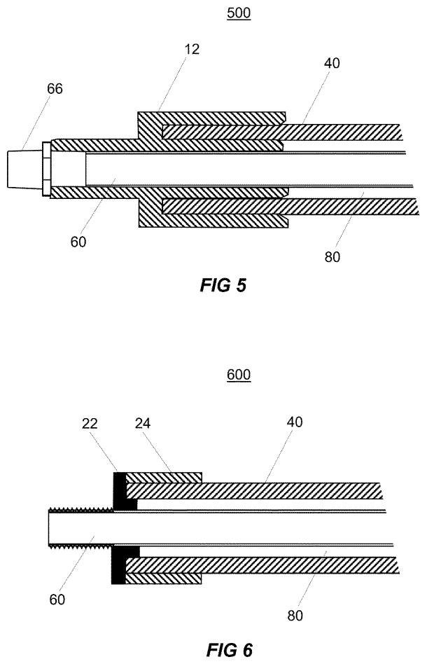

Several possibilities of joining the conduit 10 to the filter module 90 are disclosed in this disclosure. FIG. 5 shows one such possibility. Here, in the design 500 there is a hollow connector 12 that is adjusted and extended both inside to the intermediate space and outside of the tubular filter 40 at its first side 40b. Another end of the hollow connector 12 is adjusted to and aligned with the end of the suction tube 60 joined together with the inlet 30 of the conduit, the inlet is not shown in the figure. A nipple 66 may be inserted between the suction tube 60 and the inlet 30, the nipple 66 is shown in the figure. The nipple 66 may or may not contain threading, depending on the embodiment.

FIG. 6 shows another possibility of joining the conduit 10 to the filter module 90. In this design 600 a part of the suction tube 60 that is outside from the first end 40a of the tubular filter 40 comprises threading to be fitted to the respective threading in the head of the inlet 30 of the conduit, that joining is not shown in the figure. Additionally, the design 600 comprises a sealing member 22 that is adapted to seal the end of the intermediate space 80 at the first side 40a of the tubular filter 40. Advantageously, the sealing member 22 extends to the intermediate space 80 for enhancing and/or securing the sealing of the intermediate space 80.

Additionally with the sealing member 22, there may be also a sleeve 24 on the exterior wall of the tubular filter 40 at its first side 40a for further securing the sealing member, as shown in the figure. Additionally or alternatively, the sleeve 24 may be used for closing/sealing the pores of the tubular filter 40 at its first side 40a.

Suitable materials for the part of the tubular filter 40 providing the filter media, such as a membrane for filtering, can include polymeric material. Preferably, the polymeric material is thermoplastic polymer such as polyamide, polyethylene, and polytetrafluoroethylene or any mixture thereof. A suitable example for such polymers is polyethylene. The membrane may be manufactured by thermal sintering, for instance. Alternatively or additionally, the membrane can include ceramic. Preferably, the ceramic is made from inorganic material comprising alumina, titania, zirconia oxide, and silicon carbide or any mixture thereof.

FIG. 7 shows a schematic illustration of the tubular filter 40. In the upper-left corner in the figure is shown a scanning electron microscope (SEM) image of an example 701 of the filter media of the tubular filter 40. In the lower-left corner in the figure is shown a SEM image of another example 702 of the filter media of the tubular filter 40. Both examples 701 and 702 were made by thermal sintering HDPE particles. Both 701 and 702 were tested and considered suitable for the filtering in the filtering device used in the manufacturing process of an aqueous slurry described herein above and below.

The porosity characteristics of examples 701 and 702 were studied by conducting Hg porosity measurements for the samples of 701 and 702. Table 1 below summarizes the obtained porosity characteristics of 701 and 702. The Hg porosity measurements were done by the device of Anton Paar PoreMaster 60-GT according to the manufacturer's instructions with the following conditions: a sample cell was 1.5 inch, an intrusion pressure range was 0.721 PSIA to 50.063 PSIA and an extrusion pressure range was 49.436 PSIA to 0.724 PSIA.

TABLE 1

| | | | | Median | Median |
|---|---|---|---|---|---|
| | Total | | Total | pore | pore |
| | intruded | Total | Pore | Diameter | Diameter |
| | volume | porosity | area | (volume) | (Area) |
| Sample | cc/g | % | m2/g | μm | μm |
| 701 | 0.7310 | 9.69 | 0.2090 | 13.84 | 12.26 |
| 702 | 0.3511 | 5.55 | 0.1332 | 9.791 | 8.864 |

The wall thickness of the part of the tubular filter 40 providing the filter media, such as a membrane, may vary depending on the application. It can, for instance, be in the range of approximately 0.5 mm to 20 mm.

There are various suitable materials for the conduit and the suction tube. As described hereinabove, the suction tube is made of material that is advantageously impermeable to air and other gases and to liquids such as to liquids to be filtered. For instance, stainless steel can be used.

The dimensions of the filtering device, and especially the dimensions of the tubular filter(s) of the filter unit(s) affecting filtering performance such as in terms of the effective filter area, are dependent on the characteristics of the used filter media, e.g., its porosity, and an application where the filtering device is used. However, advantageously, the filtering performance, i.e. how much is it possible to filtrate through the filtering device, is at least approximately the same as the predetermined solution feed rate into the reactor. This can be achieved, for instance, by varying the number of the filter modules 90 and the parts therein and their dimensions including their dimensions of cross-sections and lengths and/or by varying the characteristics of the filter media of the tubular filter(s), for instance. This can easily be done by the skilled person within the scope of the appended claims.

Several advantageous possibilities of providing the filtering device are described hereinabove. The individual measures can be advantageously combined with each other.

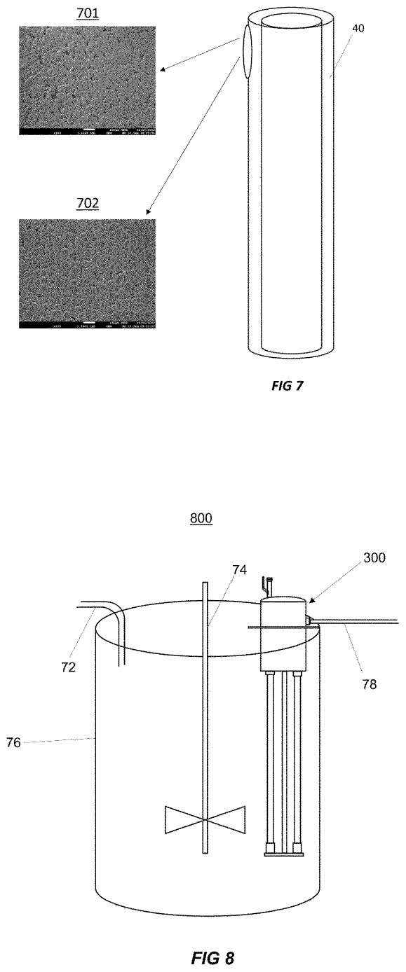

FIG. 8 shows one possible design 800 of another aspect of the invention that is a reaction vessel suitable for precipitating hydroxide or oxyhydroxide of one or more metal elements, the reaction vessel comprises the filtering device according to the first aspect of the invention.

The design 800 comprises the filtering device 300 as described above mounted on a top of a reactor container 76. Further, it 800 comprises a filtrate discharge line 78 connected to the outlet 20 of the filtering device for discharging the filtrate, i.e. fluid to be filtrated through the device 300. Still further it 800 comprises a raw material supply line 72 arranged to supply raw materials such as a mixture of metal solutions, to inside the reactor container 76 and a mixer 74 arranged to mix the raw materials fed to the reactor container 76. The filtrate discharge line 78 may comprise a vacuum pump or the like, not shown in the figures, for creating a vacuum inside the filtering device as described hereinabove.

To avoid or lessen contamination and/or blockage of the tubular filter of the filtering device, advantageously the raw material supply line 72 and the filtering device are located opposite sides inside the reactor, as shown in the figure.

The reaction vessel may comprise an external filtrate storage tank fluidly connected to the outlet of the filtering device for storing the filtrate, not shown in the figures.

In further another aspect of the invention, a method for manufacturing an aqueous slurry is disclosed. The method comprises supplying and mixing raw materials including a first aqueous solution comprising a metal salt of one or more elements, such as metal elements, in a desired mixture ratio and a second aqueous solution comprising a precipitant in a reaction vessel. The one or more elements include at least one of Ni, Co and Mn. When a predetermined liquid level inside the reaction vessel is reached, which may be, e.g., 80-100% of the inside volume of the reaction vessel, depending on the application, the method further comprises increasing the solid fraction of the aqueous slurry by vacuum filtrating the aqueous slurry inside the reaction vessel through the filtering device according to the first aspect of the invention.

The solid fraction of the obtained aqueous slurry may contain, depending on the precipitant used, either hydroxide or carbonate particles. Such particles can be used as precursor material of lithium transition metal cathode materials for positive electrodes. A desired precursor material, regarding e.g. its desired chemical composition and size, can be obtained by washing and drying the product obtained according to the manufacturing process of the aqueous slurry.

For instance, the filtering may be executed in such a way that there are predetermined lower and upper limits for the liquid level when the filtering device is arranged to keep the liquid level between said limits.

The supplying and mixing raw materials in the method may further comprise supplying and mixing a third aqueous solution comprising a complexing agent in the reaction vessel. The complexing agent may be selected from ammonia, glycine, tartrate, citrate, and oxalate or the like. The content of the complexing agent may be used at any suitable amount generally used in the art for complexing agents. The complexing agent is, for example, aqueous ammonia.

Advantageously, the liquid level inside the reaction vessel can be kept substantially constant by adjusting the volume of the filtrate discharged from the filtering device and the volume of the raw materials fed to the reaction vessel per a time unit substantially to the same value.

The method step of supplying and mixing raw materials may be preceded by any of the following step or any of the combination thereof: 1) providing a full or partial inert gas atmosphere inside the reaction vessel by passing an inert gas, such as N₂ gas, and/or a mixture of gases, such as a mixture of N₂ gas and air, through the reaction vessel, 2) providing a starting solution to the reaction vessel, comprising providing an aqueous solution comprising one or more precipitants and a possible complexing agent, and 3) adjusting and maintaining a desired temperature inside the reaction vessel.

1-18. (canceled)

19. A filtering device for a reaction vessel, the filtering device comprising:
a conduit for conducting a filtrate to outside of the reaction vessel, the conduit comprising an inlet and an outlet; and
a filter module comprising a tubular filter having a first end and a second end, the first end of the tubular filter being open and the second end of the tubular filter being sealed,
the filter module comprises a suction tube arranged to extend inside of the tubular filter between the first end and the second end of the tubular filter, wherein there is an intermediate space between the tubular filter and the suction tube, and wherein the intermediate space is fluidly connected to the inlet of the conduit via the suction tube.

20. The filtering device according to claim 19, wherein the tubular filter comprises a membrane being made of a polymeric material.

21. The filtering device according to claim 19, wherein the tubular filter comprises a membrane being made of a ceramic.

22. The filtering device according to claim 19, wherein an end of the intermediate space (80) toward the conduit is sealed.

23. The filtering device according to claim 19, wherein the tubular filter is adapted for solid-liquid filtration of particles having the size of 0.5 μm or less.

24. The filtering device according to claim 19, wherein the suction tube comprises a tubular wall that is impermeable to the filtrate.

25. The filtering device according to claim 19, wherein the filtering device comprises a plurality of filter modules installed apart from each other, wherein each intermediate space of the plurality of the filter modules being fluidly connected to the inlet of the conduit.

26. The filtering device according to claim 25, wherein the conduit comprises a plurality of inlets, and wherein each intermediate space of the plurality of the filter modules being fluidly connected to one inlet.

27. The filtering device according to claim 25, wherein the filtering device comprises a stem disposed such that a proximal end of the stem being secured to the conduit and a distal end of the stem being secured to a support member, and wherein the second ends of the tubular filters of the plurality of filter modules are supported by the support member from a side of the support member facing towards the conduit.

28. The filtering device according to claim 27, wherein the second end of tubular filter of each filter modules being installed in a respective support element of the support member.

29. The filtering device according to claim 25, wherein the plurality of filter modules is arranged in a circular pattern.

30. The filtering device according to claim 19, wherein the conduit comprises an inside space, wherein the inlet of the conduit and the outlet of the conduit are fluidically connected via the inside space of the conduit, and wherein the inlet of the conduit extends higher to inside space compared to the outlet of the conduit when viewed from side in a way that the second end of at least one tubular filter points downward.

31. The filtering device according to claim 19, wherein the conduit comprises a gas inlet.

32. A reaction vessel for precipitating, the reaction vessel comprising a filtering device according to claim 19.

33. The reaction vessel according to claim 32, wherein the reaction vessel comprises an external filtrate storage tank fluidly connected to the outlet of the filtering device for storing the filtrate separated through the filtering device.

34. A method for manufacturing an aqueous slurry, the method comprising:
supplying and mixing a first aqueous solution comprising a metal salt of one or more elements, and a second aqueous solution comprising a precipitant in a reaction vessel, thereby forming an aqueous slurry comprising a liquid fraction and a solid faction, and when a predetermined liquid level inside the reaction vessel is reached the method further comprising:
increasing the solid fraction of the aqueous slurry by vacuum filtrating the aqueous slurry inside the reaction vessel through a filtering device according to claim 19.

35. The method according to claim 34, wherein the precipitant comprises a hydroxide or at least one selected from a carbonate and a bicarbonate.

36. The method according to claim 34, wherein the method further comprising supplying and mixing a third aqueous solution comprising a complexing agent in the reaction vessel.
